(19) United States
(12) Patent Application Publication
(10) Pub. No.: US 2023/0321491 A1
(43) Pub. Date: Oct. 12, 2023

(54) Self-Powered Resistance-Adjustable Training Mechanism

(71) Applicant: LUXQUEEN HEALTH TECH CO., LTD., Nantou City (TW)

(72) Inventor: Shr-Yi Tsai, Taichung City (TW)

(21) Appl. No.: 18/191,977

(22) Filed: Mar. 29, 2023

(30) Foreign Application Priority Data
Apr. 11, 2022 (TW) 111203594

(51) Int. Cl. A63B 24/00; H02N 11/00

(52) U.S. Cl. CPC A63B 24/0087; H02N 11/002; A63B 22/025

(57) ABSTRACT

A self-powered resistance-adjustable training mechanism contains a trainer, a power generator, a transmission unit, and a control module. The trainer is a treadmill, and the trainer includes a chassis fixed on a tilted angle, a first wheel assembly mounted on the first end of the chassis, a second wheel assembly disposed on the second end of the chassis, and a running belt rolled between the first wheel assembly and the second wheel assembly. The transmission unit is connected between the first wheel assembly and the power generator so that the first wheel assembly actuates the power generator to produce a power. The control module electrically is connected with the power generator and is configured to receive and adjust the power from the power generator, and the power is sent to a loading device so as to provide a programmable adjustment of a resistance and a speed to the trainer.

### TECHNICAL FIELD

The present invention relates to a training mechanism, and more particularly to a self-powered resistance-adjustable training mechanism.

### BACKGROUND

With the development of science and technology, human quality of life has also improved. To satisfy the basic needs of life, more and more attention is paid to physical health. Sports training mechanisms provide different fitness and sports training functions, such as treadmills, weight training machines, rowing machines, exercise bikes, sit-up fitness machines, etc., thus providing strength training for various parts of muscles.

A conventional treadmill comprises a handrail, a chassis, a running belt, etc. The handrail is fixed on a first portion of the chassis, and a first wheel assembly and a second wheel assembly are respectively installed at the first and second ends of the chassis. The running belt is rolled between the first wheel assembly and the second wheel assembly of the chassis, such that the user runs on the running belt, thus obtaining running exercise.

At present, treadmills are mainly divided into electric treadmills and unpowered treadmills. Unpowered treadmills do not have motors, which can save the cost of motors and energy efficiency. In recent years, the unpowered treadmills have become more and more popular. There are different resistances when running on a treadmill to satisfy the needs of running. Therefore, it is known that a non-powered treadmill has a magnetic control mechanism fixed on one side of the first wheel assembly. The magnetic control mechanism includes a flywheel and an adjustment position. In use, moving a position of the magnet relative to the flywheel, a rotation resistance of the flywheel is adjustable, thus adjusting a resistance of the user when running on the treadmill.

However, such an unpowered treadmill cannot provide a programmable adjustment of a resistance and a speed by manually operated based on the user's conditions, thus reducing an exercise comfort, a training effect, and an adjustment range of the resistance and not satisfying various using requirements.

The present invention has arisen to mitigate and/or obviate the afore-described disadvantages.

### SUMMARY

The primary aspect of the present invention is to provide a self-powered resistance-adjustable training mechanism which is capable of providing a programmable adjustment of a resistance to change a speed to the trainer, thus obtaining an exercise comfort and a training effect.

Another aspect of the present invention is to provide a self-powered resistance-adjustable training mechanism by which the resistance to the trainer is adjustable to satisfy different using requirements.

To obtain the above-mentioned aspects, a self-powered resistance-adjustable training mechanism provided by the present invention contains a trainer, a power generator, a transmission unit, and a control module.

The trainer is a treadmill and includes a chassis fixed on a tilted angle so that a first end of the chassis is higher than a second end of the chassis, and the trainer includes a first wheel assembly mounted on two sides of the first end of the chassis, a second wheel assembly disposed on two sides of the second end of the chassis, and a running belt rolled between the first wheel assembly and the second wheel assembly. The transmission unit is connected between the first wheel assembly and the power generator so that the first wheel assembly actuates the power generator to produce a power. The control module is electrically connected with the power generator and is configured to receive and adjust the power from the power generator, and the power is sent to a loading device so as to provide a programmable adjustment of a resistance to the trainer, thus changing a speed of the trainer.

### BRIEF DESCRIPTION OF THE DRAWINGS

FIG. 1 is a perspective view showing the assembly of a self-powered resistance-adjustable training mechanism according to a first embodiment of the present invention.

FIG. 2 is a perspective view showing the exploded components of the self-powered resistance-adjustable training mechanism according to the first embodiment of the present invention.

FIG. 3 is a side plan view showing the assembly of the self-powered resistance-adjustable training mechanism according to the first embodiment of the present invention.

FIG. 4 is a perspective view showing the assembly of a power generator and a control module of the self-powered resistance-adjustable training mechanism according to the first embodiment of the present invention.

FIG. 5 is a block diagram showing the assembly of the power generator and the control module of the self-powered resistance-adjustable training mechanism according to the first embodiment of the present invention.

FIG. 6 is a perspective view showing the assembly of a self-powered resistance-adjustable training mechanism according to a second embodiment of the present invention.

FIG. 7 is a perspective view showing the exploded components of the self-powered resistance-adjustable training mechanism according to the second embodiment of the present invention.

FIG. 8 is a perspective view showing the assembly of a power generator and a control module of the self-powered resistance-adjustable training mechanism according to the second embodiment of the present invention.

FIG. 9 is a block diagram showing the assembly of the power generator and the control module of the self-powered resistance-adjustable training mechanism according to the second embodiment

FIG. 10 is a perspective view showing the assembly of a self-powered resistance-adjustable training mechanism according to a third embodiment of the present invention.

FIG. 11 is a perspective view showing the exploded components of the self-powered resistance-adjustable training mechanism according to the third embodiment of the present invention.

FIG. 12 is a perspective view showing the assembly of a power generator and a control module of the self-powered resistance-adjustable training mechanism according to the third embodiment of the present invention.

FIG. 13 is a block diagram showing the assembly of the power generator and the control module of the self-powered resistance-adjustable training mechanism according to the third embodiment of the present invention.

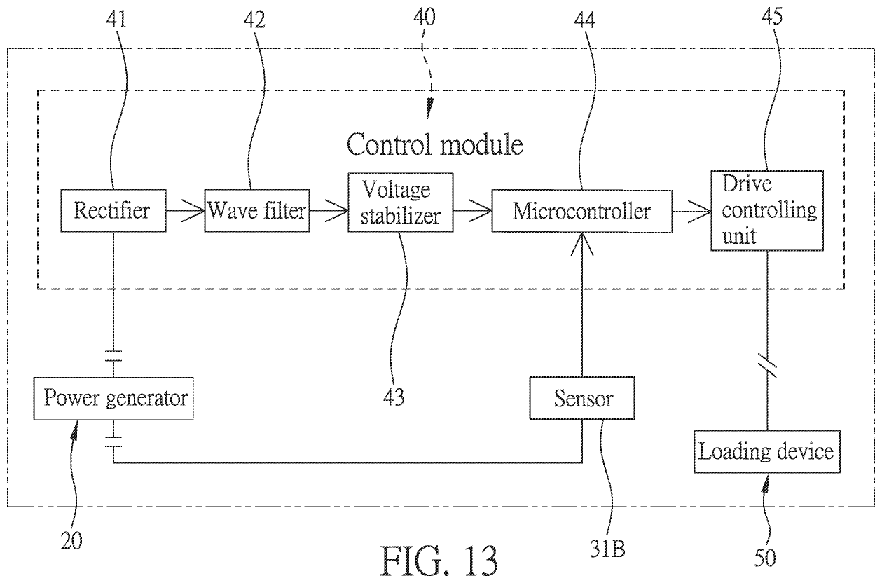

### DETAILED DESCRIPTION

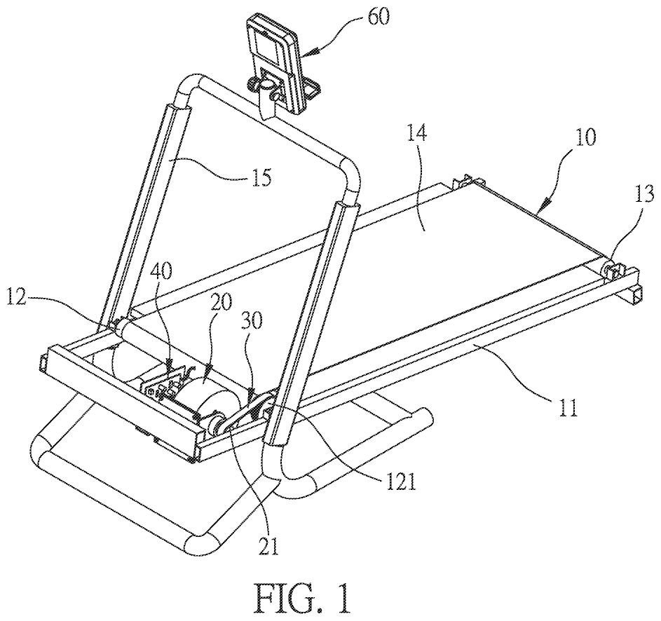

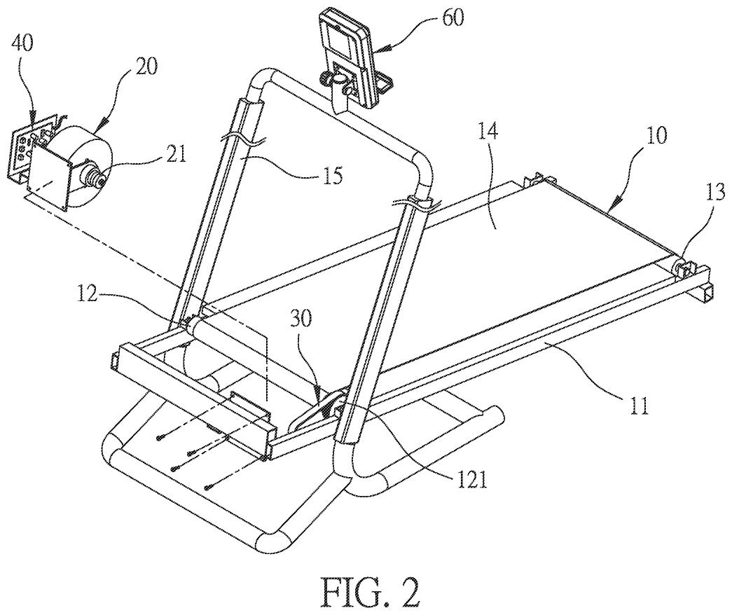

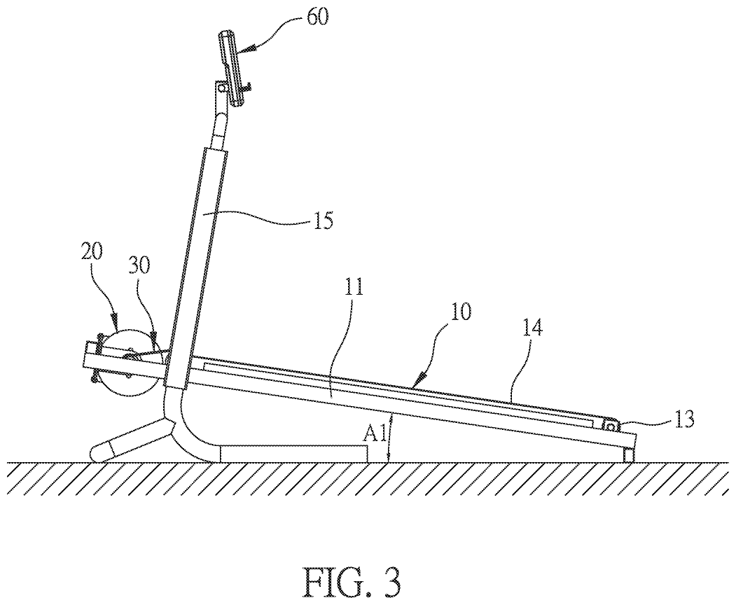

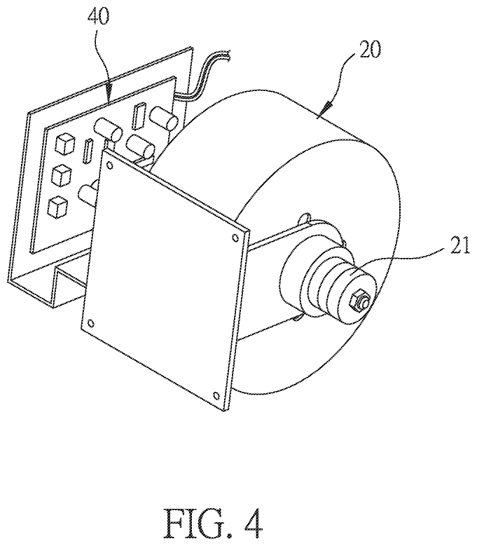

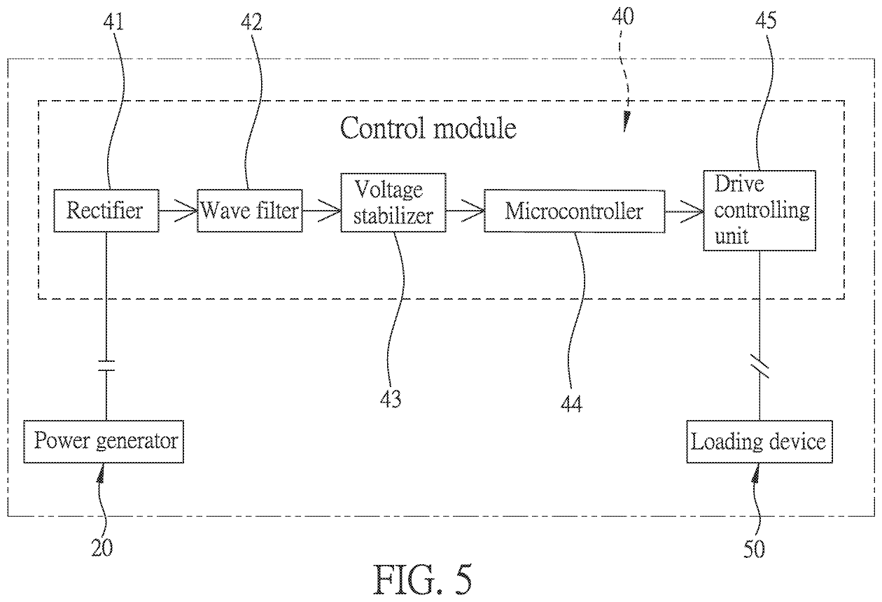

With reference to FIGS. 1-5, a self-powered resistance-adjustable training mechanism according to a first embodiment of the present invention comprises a trainer 10, a power generator 20, a transmission unit 30, a control module 40, and an operation meter 60.

The trainer 10 is a treadmill and includes a chassis 11 fixed on a tilted angle A1 so that a first end of the chassis 11 is higher than a second end of the chassis 11, and the trainer 10 includes a first wheel assembly 12 mounted on two sides of the first end of the chassis 11, a second wheel assembly 13 disposed on two sides of the second end of the chassis 11, and a running belt 14 rolled between the first wheel assembly 12 and the second wheel assembly 13, wherein the first wheel assembly 12 has a first pulley 121 fixed on an end thereof, and the trainer 10 further includes a stand 15 erected on the first end of the chassis 11.

The power generator 20 is mounted adjacent to the first wheel assembly 12 of the trainer 10, and the power generator 20 includes a second pulley 21.

The transmission unit 30 is a belt and is connected between the first pulley 121 of the first wheel assembly 12 of the trainer 10 and the second pulley 21 of the power generator 20, wherein the transmission unit 30 is actuated by the first wheel assembly 12 to produce a power.

The control module 40 is electrically connected with the power generator 20 and is configured to receive and adjust the power from the power generator 20, and the power is sent to a loading device 50 so as to provide a programmable adjustment of a resistance and a speed to the trainer 10, wherein the control module 40 includes a rectifier 41, a wave filter 42, a voltage stabilizer 43, a microcontroller 44, and a drive controlling unit 45 which are electrically connected, and the loading device 50 is a resistor or an inductor.

The operation meter 60 is configured to built-in a program or the program is set by a user so that the control module 40 is commended to execute the program and to display data to the user.

Since the first end of the chassis 11 is fixed higher than the second end of the chassis 11 at the tilted angle A1, the user runs or walks automatically on the running belt 14 so that the first wheel assembly 12 and the second wheel assembly 13 are driven to rotate, the power generator 20 is driven by the first wheel assembly 12 to produce the power, and the power is sent to the control module 40 so as to be adjusted and sent to the loading device 50, wherein the drive controlling unit 45 provides the programmable adjustment of the resistance and the speed to the running belt 14 of the trainer 10, thus obtaining an exercise confront and a training effect.

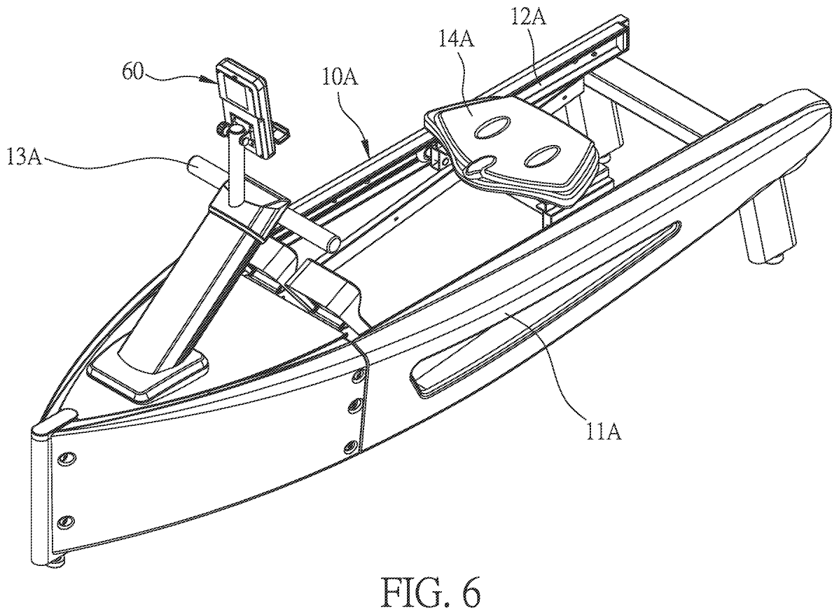

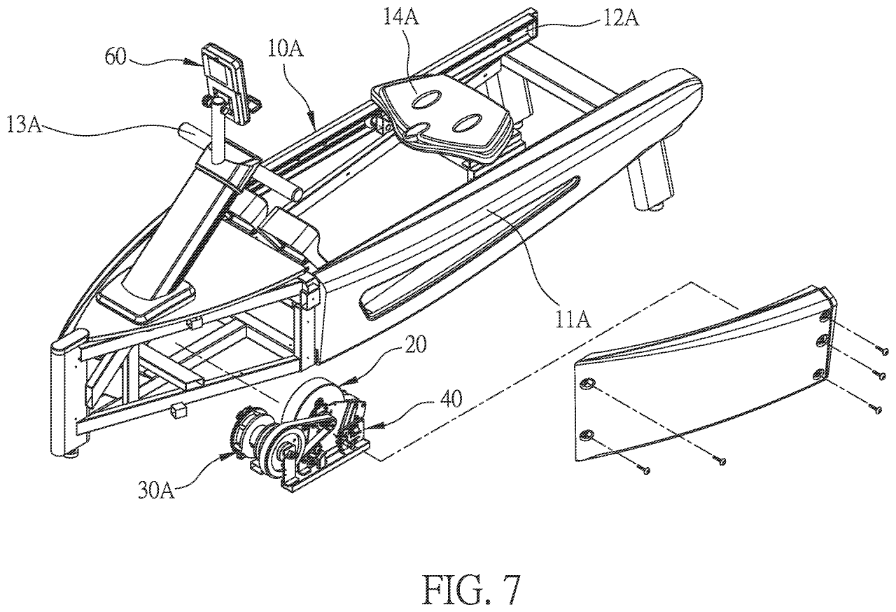

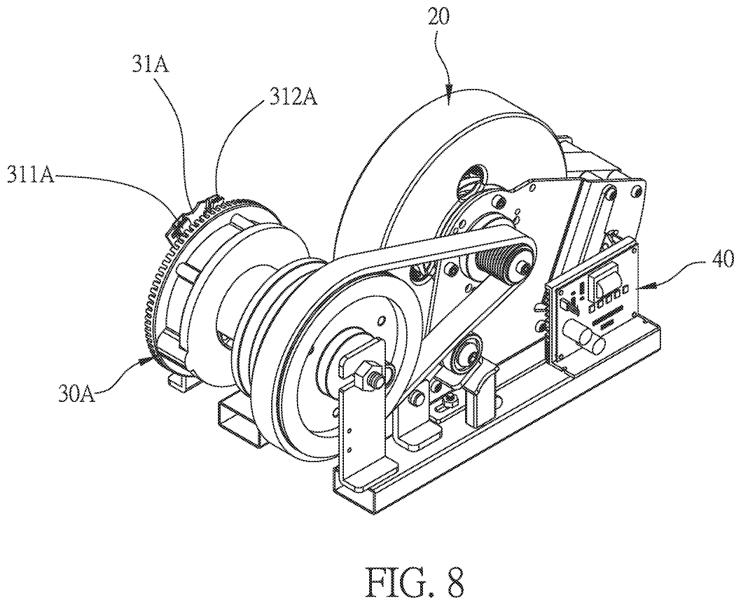

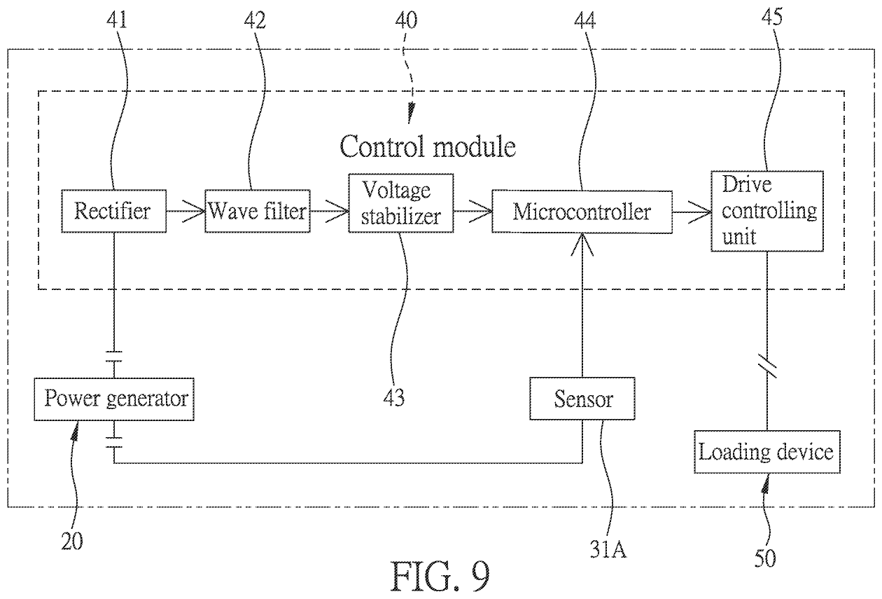

Referring to FIGS. 6-9, a self-powered resistance-adjustable training mechanism according to a second embodiment of the present invention comprises a trainer 10A, a power generator 20, a transmission unit 30A, a control module 40, and an operation meter 60.

The trainer 10A is a rowing machine and includes a body 11A, a slide rail 12A, a pulling unit 13A in front of the slide rail 12A arranged on the body 11A, and a slidable cushion 14A sliding forward and backward on the slide rail 12A.

The power generator 20 is mounted on a first end of the trainer 10A.

The pulling unit 13A includes a bearing and a reciprocating mechanism.

The transmission unit 30A is connected between the pulling unit 13A of the trainer 10A and the power generator 20 so that the pulling unit 13A of the trainer 10A actuates the power generator 20 to produce the power by using the transmission unit 30A, wherein the transmission unit 30A includes a sensor 31A configured to calculate a moving travel and a moving direction of the pulling unit 13A, and the sensor 31A includes a first sensing portion 311A and a second sensing portion 312A.

The control module 40 is electrically connected with the power generator 20 and is configured to receive and adjust the power from the power generator 20, and the power is sent to a loading device 50 so as to provide a programmable adjustment of a resistance to the trainer 10A, wherein the control module 40 includes a rectifier 41, a wave filter 42, a voltage stabilizer 43, a microcontroller 44, and a drive controlling unit 45 which are electrically connected, and the loading device 50 is a resistor or an inductor, wherein the sensor 31A is electrically connected with the microcontroller 44 of the control module 40.

The operation meter 60 is configured to built-in a program or the program is set by a user so that the control module 40 is commended to execute the program and to display data to the user.

As desiring to exercise by pulling and pushing the rowing machine backward and forward reciprocately, the user sits on the seat cushion 14A and pulls the pulling unit 13A backward with two hands so that the seat cushion 14A slides along the slide rail 12A backward. When pushing the rowing machine forward with the user's abdomen and the two hands, the seat cushion 14A is driven to slide back to an original position forward, and the pulling unit 13A is moved to an original state by using the bearing and the reciprocating mechanism, thus obtaining the exercise by rowing the trainer. In the meantime, the transmission unit 30A is actuated by the pulling unit 13A to drive the power generator 20 to produce the power, and the power is sent to the control module 40A from the power generator 20, wherein the first sensing portion 311A and the second sensing portion 312A of the sensor 31A mate with the control module 40 to calculate the moving travel and the moving direction of the pulling unit 13A, and the power is adjustable by the control module 40 and is sent to the loading device 50 so that a programmable adjustment of the resistance is provided to the pulling unit 13A of the trainer 10, thus obtaining an exercise comfort and a training effect.

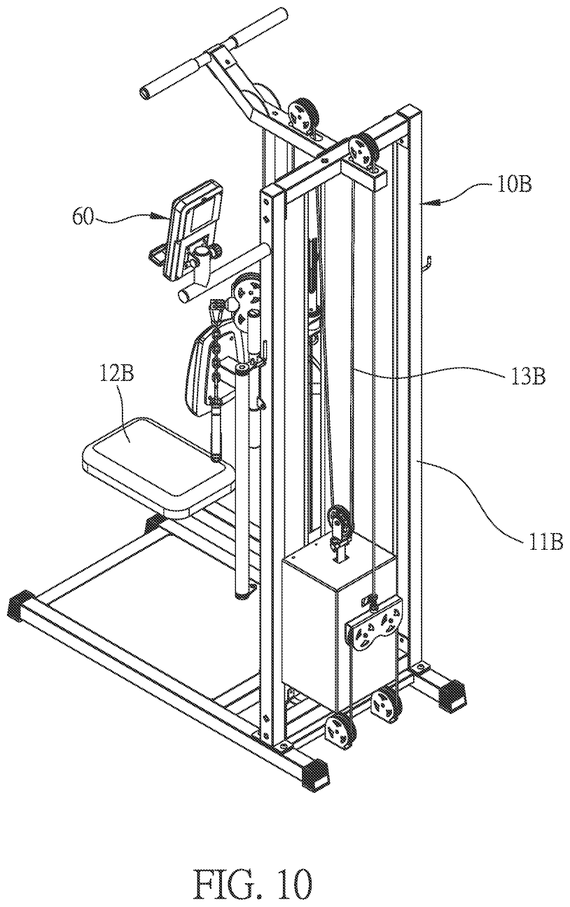

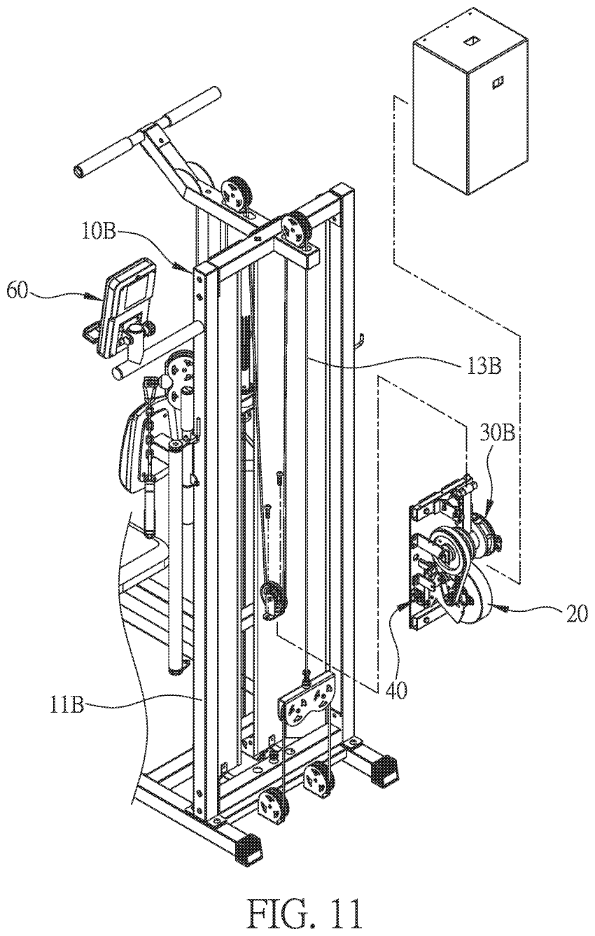

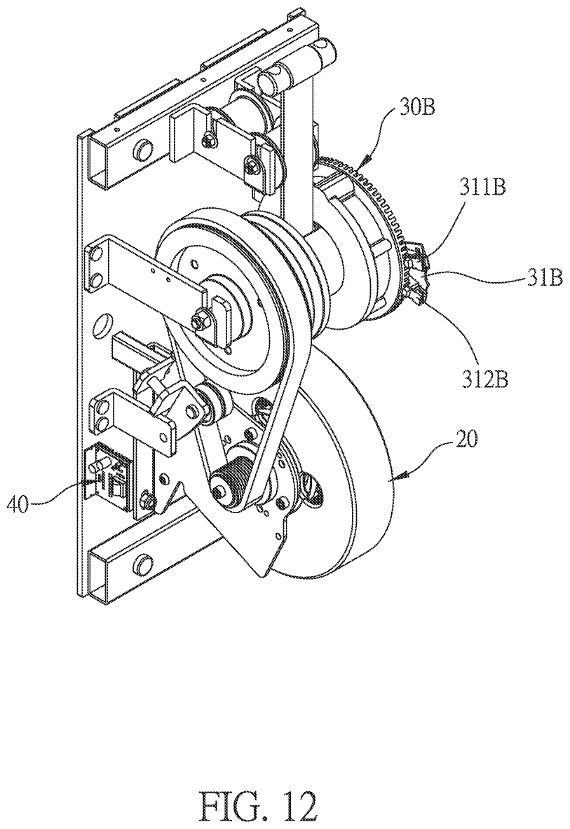

As shown in FIGS. 10-12, a self-powered resistance-adjustable training mechanism according to a third embodiment of the present invention comprises: a trainer 10B, a power generator 20, a transmission unit 30B, a control module 40, and an operation meter 60.

The trainer 10B is a weight training machine and includes a body 11B, a seat 12B arranged on the body 11B, and a pulling unit 13B extending from a top of the seat 12B to a rear side of the seat 12B.

The power generator 20 is mounted on a first end of the trainer 10B.

The pulling unit 13A includes a bearing and a reciprocating mechanism.

The transmission unit 30B is connected between the pulling unit 13B of the trainer 10B and the power generator 20 so that the pulling unit 13B of the trainer 10B actuates the power generator 20 to produce the power by using the transmission unit 30B, wherein the transmission unit 30B includes a sensor 31B configured to calculate a moving travel and a moving direction of the pulling unit 13B, and the sensor 31B includes a first sensing portion 311B and a second sensing portion 312B.

The control module 40 is electrically connected with the power generator 20 and is configured to receive and adjust the power from the power generator 20, and the power is sent to a loading device 50 so as to provide a programmable adjustment of a resistance and a speed to the trainer 10B, wherein the control module 40 includes a rectifier 41, a wave filter 42, a voltage stabilizer 43, a microcontroller 44, and a drive controlling unit 45 which are electrically connected, and the loading device 50 is a resistor or an inductor, wherein the sensor 31B is electrically connected with the microcontroller 44 of the control module 40.

The operation meter 60 is configured to built-in a program or the program is set by a user so that the control module 40 is commended to execute the program and to display data to the user.

As desiring to exercise by pulling and retracting the weight training machine reciprocately, the user sits on the seat 12B and pulls and retracting the pulling unit 13B reciprocately by way of the bearing and the reciprocating mechanism. In the meantime, the transmission unit 30B is actuated by the pulling unit 13B to drive the power generator 20 to produce the power, and the power is sent to the control module 40 from the power generator 20, wherein the first sensing portion 311B and the second sensing portion 312B of the sensor 31B mate with the control module 40 to calculate the moving travel and the moving direction of the pulling unit 13B, and the power is adjustable by the control module 40 and is sent to the loading device 50, wherein the drive controlling unit 45 provides the programmable adjustment of the resistance is provided to the pulling unit 13B of the trainer 10B, thus obtaining the exercise comfort and the training effect.

Thereby, the self-powered resistance-adjustable training mechanism has advantages as follows:
1) The self-powered resistance-adjustable training mechanism is not supplied an external power but produces the power itself to provide the programmable adjustment of the resistance to the trainer 10, 10A, 10B, thus obtaining the exercise confront and the training effect.
2) The resistance to the trainer 10, 10A, 10B is adjustable to satisfy different using requirements.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A self-powered resistance-adjustable training mechanism comprising:
a trainer being a treadmill and including a chassis fixed on a tilted angle so that a first end of the chassis is higher than a second end of the chassis, and the trainer including a first wheel assembly mounted on two sides of the first end of the chassis, a second wheel assembly disposed on two sides of the second end of the chassis, and a running belt rolled between the first wheel assembly and the second wheel assembly;
a power generator;
a transmission unit connected between the first wheel assembly and the power generator so that the first wheel assembly actuates the power generator to produce a power; and
a control module electrically connected with the power generator and configured to receive and adjust the power from the power generator, and the power being sent to a loading device so as to provide a programmable adjustment of a resistance to the trainer, thus changing a speed of the trainer.

2. The self-powered resistance-adjustable training mechanism as claimed in claim 1, wherein the first wheel assembly has a first pulley fixed on an end thereof, the power generator includes a second pulley, and the transmission unit is a belt and is connected between the first pulley and the second pulley.

3. The self-powered resistance-adjustable training mechanism as claimed in claim 1, wherein the trainer further includes a stand erected on the first end of the chassis.

4. The self-powered resistance-adjustable training mechanism as claimed in claim 1, wherein the control module includes a rectifier, a wave filter, a voltage stabilizer, a microcontroller, and a drive controlling unit which are electrically connected.

5. The self-powered resistance-adjustable training mechanism as claimed in claim 1, wherein the loading device is a resistor or an inductor.

6. The self-powered resistance-adjustable training mechanism as claimed in claim 1 further comprises an operation meter configured to built-in a program or the program is set by a user so that the control module is commended to execute the program and to display data to a user.

7. A self-powered resistance-adjustable training mechanism comprising:
a trainer including a pulling unit;
a power generator;
a transmission unit connected between the pulling unit of the trainer and the power generator so that the pulling unit of the trainer actuates the power generator to produce a power by using the transmission unit, wherein the transmission unit includes a sensor configured to calculate a moving travel and a moving direction of the pulling unit, and the sensor includes a first sensing portion and a second sensing portion; and
a control module electrically connected with the power generator and configured to receive and adjust the power from the power generator, and the power being sent to a loading device so as to provide a programmable adjustment of a resistance to the trainer.

8. The self-powered resistance-adjustable training mechanism as claimed in claim 7, wherein the trainer is a rowing machine and includes a body, a slide rail arranged on the body, the pulling unit in front of the slide rail, and a slidable cushion sliding forward and backward on the slide rail, wherein the pulling unit includes a bearing and a reciprocating mechanism.

9. The self-powered resistance-adjustable training mechanism as claimed in claim 7, wherein the trainer is a weight training machine and includes a body, a seat arranged on the body, and the pulling unit extending from a top of the seat to a rear side of the seat.

10. The self-powered resistance-adjustable training mechanism as claimed in claim 7, wherein the control module includes a rectifier, a wave filter, a voltage stabilizer, a microcontroller, and a drive controlling unit which are electrically connected.

11. The self-powered resistance-adjustable training mechanism as claimed in claim 7, wherein the loading device is a resistor or an inductor.

12. The self-powered resistance-adjustable training mechanism as claimed in claim 7 further comprising an operation meter configured to built-in a program or the program is set by a user so that the control module is commended to execute the program and to display data to a user.
